(19) United States
(12) Patent Application Publication
(10) Pub. No.: US 2009/0190087 A1
(43) Pub. Date: Jul. 30, 2009

(54) Flexible Auxiliary Clip-On Glasses Frame

(76) Inventor: Roger Wei Yi Hsu, Rancho Cucamonga, CA (US)

Correspondence Address: AGNEW INTERNATIONAL;PATENT & TRADEMARK LAW FIRM, 1300 BRISTOL STREET NORTH, SUITE 100, NEWPORT BEACH, CA, 92660, US

(21) Appl. No.: 12/274,909

(22) Filed: Nov. 20, 2008

Related U.S. Application Data
(60) Provisional application No. 60/990,576, filed on Nov. 27, 2007.

(51) Int. Cl. G02C 9/04

(52) U.S. Cl. 351/57

(57) ABSTRACT

An auxiliary clip-on frame for mounting on eyeglasses is disclosed. It includes an auxiliary glasses frame which includes a left frame part and a right frame part where each of said frame parts contains lens retaining portion, a bridge element, and at least one clamp. The front side of the auxiliary glasses frame is made with plastic or metal material and a back side of the auxiliary glasses frame is made with soft rubber like material. The auxiliary glasses frame capable of attaching to eyeglasses where the auxiliary glasses frame will not scratch the surface of the eyeglasses when the auxiliary glasses frame is attached to the eyeglasses.

### CROSS REFERENCE TO RELATED APPLICATION

This application claims the benefit of priority under 35 U.S.C. 119(e) to the filing date of U.S. provisional patent application No. 60/990,576 entitled “Flexible Auxiliary Clip-On Glasses Frame” which was filed Nov. 27, 2007, and is incorporated herein by reference.

### FIELD OF INVENTION

This invention relates to an eye protection frame and more particularly to flexible auxiliary glasses designed to be removable and attached to and supported by a pair of ordinary eyewear. The flexible auxiliary glasses, which may be eye protectors or the like, commonly sunglasses, relates to a clip-on frame and more particularly to a clip-on frame with flexible material that permits the frame to be easily and securely mounted on eyeglasses and free from scratching the ordinary eyewear.

### BACKGROUND

One common type of auxiliary clip-on auxiliary glasses frame mounting mechanism uses clamp which is attached to the bridge of the eyewear frame. It includes pairs of opposing prongs which are spring loaded toward each other so as to retain the lenses of the eyeglasses between the prongs. Examples of this clamp-type mechanism are disclosed in U.S. Pat. No. 3,575,497 issued Apr. 20, 1971 to Leblanc, and U.S. Design Pat. No. Des 350,359 issued Sep. 6, 1994 to Friedman.

However, clamp-type mechanisms have their disadvantages. The prongs must clamp tightly to the lenses, thereby scratching the lenses. In addition, this type of mechanism has several inter-engaging parts which requires precise fabrication precisely and assembled, making it relatively expensive to produce.

Another common type of clip-on auxiliary glasses frame mounting mechanism relates to frame that is free from contacting or clamping the lenses of the eyeglasses and utilizes one or more sets of spring loaded prongs. The prongs are movably or flexibly mounted on the sunglass frame frame such that they can be moved against a spring force, for insertion between spaced portions of the eyeglasses frame. The spring force causes the prongs to frictionally engage the eyeglasses frame. Because the prongs only touch the eyewear frame, the lenses of the eyewear are not clamped or otherwise engaged. Example of this spring-prong type mechanism is disclosed in U.S. Pat. No. 6,234,628 issued May 22, 2001 to Friedman.

However, the spring-prong type mechanisms also have their disadvantages. The prongs clamp tightly to the eyewear frames, often scratching and damaging the ordinary eyewear frames as a result. This is especially problematic if the ordinary eyewear frame is coated with paint and the clip-on auxiliary glasses frame scratches the paint off the frame.

Accordingly, an auxiliary clip-on glasses frame that does not scratch or damage either the eyewear frames of the eyewear lenses is needed.

### SUMMARY OF INVENTION

The present invention overcomes the previous problems of auxiliary clip-on glasses frame scratching the ordinary eyeglasses frame or lenses by designing the auxiliary clip-on glasses to be a flexible unit by using flexible materials such as soft plastic, silicon, soft rubber or similar soft material to construct the auxiliary clip-on glasses frame. In this respect, because the flexible auxiliary clip-on glasses frame is made of flexible material and that because the frame itself is flexible, the auxiliary clip-on glasses frame will not scratch either the frame or the lens of the ordinary eyeglasses.

In one embodiment, the bridge element of the flexible auxiliary clip-on glasses frame can additionally incorporate memory metal, also known as shape memory alloy (SMA), to support the form of the auxiliary clip-on glasses frame of the present invention.

In another embodiment, the flexible auxiliary clip-on glasses frame can additionally add memory metal around the entire frame to support the form of the auxiliary clip-on glasses frame. For example, in adding the memory metal, the flexible auxiliary clip-on glasses frame is made by adding beta titanium to the frame and manufactured utilizing coinjection technology or insert injection technology.

In one other embodiment, the flexible auxiliary clip-on glasses frame incorporates a two layer design where the hard surface side of the auxiliary clip-on glasses frame is made with either plastic, hand made sheet stock metal or metal compress die cut materials and the soft-surface side is made with a layer of soft material such as soft rubber like material such as soft rubber, silicon or similar soft material. The two layers are combined using various available attachment methods such as the use of glue or the use of fasteners like screws or the likes.

In yet another embodiment the flexible auxiliary clip-on glasses frame contains spring mechanism over the bridge element of the frame which allows the left frame and the right frame of the flexible auxiliary clip-on glasses frame to extent and retract from the center of frame.

In yet another embodiment the flexible auxiliary clip-on glasses frame contains clamp mechanism designed to clamp the flexible auxiliary clip-on glasses frame to the temple of the ordinary eyeglasses.

In yet another embodiment the flexible auxiliary clip-on glasses frame incorporates temple like extension, preferably on both sides of the frame, and magnets designed to attached the flexible clip-on auxiliary glasses frame to the temple of the ordinary eyeglasses are housed inside the temple like extension of the flexible auxiliary clip-on glasses frame.

In yet another embodiment, the flexible auxiliary clip-on glasses frame is mounted to the front of the ordinary eyewear. In another embodiment, the flexible auxiliary clip-on glasses frame is mounted to the back the ordinary eyewear. In yet another embodiment, the flexible auxiliary clip-on glasses frame contains a single lens construction where the single lens construction contains a left lens portion, a right lens portion, and a bridge portion connecting the left lens portion and the right lens portion.

### BRIEF DESCRIPTION OF THE DRAWING

FIG. 1 is a perspective view of the preferred embodiment of the present invention showing the flexible auxiliary clip-on glasses frame utilizing the two layer design where the hard surface side of the frame is made with plastic or metal materials and the soft surface side of the frame is made with soft rubber like material. Here, the clip-on frame is attached to the front of the ordinary eyewear.

FIG. 2 is a perspective view of another embodiment of the flexible auxiliary clip-on glasses frame showing the flexible auxiliary clip-on glasses frame utilizing the two layer design where the hard surface side of the frame is made with plastic or metal material and the soft surface side of the frame is made with soft rubber like material. Here, the clip-on frame is attached to the back of the eyewear using clamps designed to clamp to the temple of the ordinary eyewear.

FIG. 3 is a perspective view of another embodiment of the flexible auxiliary clip-on glasses frame showing the flexible auxiliary clip-on glasses frame incorporating spring mechanism over the bridge area of the frame.

FIG. 4 is a perspective view of another embodiment of the flexible auxiliary clip-on glasses frame where the clip-on frame incorporates temple like extension on both sides of the frame and magnets designed to attach the flexible auxiliary clip-on glasses frame to the temple of the ordinary eyeglasses are housed in the temple like extension.

FIG. 5 is a perspective view of another embodiment of the flexible auxiliary clip-on glasses frame where the clip-on frame contains a single lens construction.

FIG. 6 is a perspective view of another embodiment of the flexible auxiliary clip-on glasses frame showing the frame made of soft plastic or rubber like material where the clip-on frame is attached to the back of the eyewear using niche like clamps designed to clamp to the temple of the ordinary eyewear.

FIG. 7 is a cross sectional view of the embodiment of the flexible auxiliary clip-on glasses frame of FIG. 1 or FIG. 2 showing the frame utilizing a two layer design where the frame is made with plastic or metal material on one side and the other side of the frame made with soft rubber like material.

### DETAILED DESCRIPTION OF THE INVENTION

The present invention discloses an flexible auxiliary clip-on glasses frame made of flexible material such as soft plastic, silicon, soft rubber or similar soft material where the frame itself is flexible and the auxiliary clip-on glasses frame will not scratch either the frame or the lens of the ordinary eyeglasses.

Specifically disclosed is an auxiliary clip-on frame for mounting on eyeglasses comprising an auxiliary glasses frame comprising a left frame part and a right frame part, each of the frame parts comprising lens retaining portion, a bridge element, and at least one clamp, where the auxiliary glasses frame is made of flexible material; wherein the auxiliary glasses frame is capable of attaching to an eyeglasses by attaching the clamp to the eyeglasses; wherein the auxiliary glasses frame will not scratch the surface of the eyeglasses when the auxiliary glasses frame is attached to the eyeglasses.

In one embodiment, the bridge area of the flexible auxiliary clip-on glasses frame can additionally incorporate memory metal, also known as shape memory alloy (SMA), to support the form of the auxiliary clip-on glasses frame of the present invention. A smart memory alloy (SMA, also known as a smart alloy, memory metal, or muscle wire) is an alloy that remembers its shape. After a sample of SMA has been deformed from its original crystallographic configuration, it regains its original geometry by itself during heating (one-way effect) or, at higher ambient temperatures, simply during unloading (pseudo-elasticity or super-elasticity)

In another embodiment, the flexible auxiliary clip-on glasses frame can additionally add memory metal around the entire frame to support the form of the auxiliary clip-on glasses frame. For example, in adding the memory metal, the flexible auxiliary clip-on glasses frame is made by adding beta titanium to the frame and manufactured utilizing coinjection technology or insert injection technology.

In one other embodiment, the flexible auxiliary clip-on glasses frame incorporates a two layer design where the hard-surface side of the auxiliary clip-on glasses frame is made with either plastic, hand made sheet stock metal or metal compress die cut materials and the soft-surface side is made with a layer of soft rubber like material such as soft rubber, silicon or similar soft material. The two layers are combined using various available attachment methods such as the use of glue or the use of fasteners like screws or the likes.

In yet another embodiment the flexible auxiliary clip-on glasses frame contains spring mechanism over the bridge element of the frame which allows the left frame and the right frame of the flexible auxiliary clip-on glasses frame to extent and retract from the center of frame.

In yet another embodiment the flexible auxiliary clip-on glasses frame contains clamp mechanism designed to clamp the flexible auxiliary clip-on glasses frame to the temple of the ordinary eyeglasses.

In yet another embodiment the flexible auxiliary clip-on glasses frame incorporates temple like extension on both sides of the frame and magnets designed to attached the flexible clip-on auxiliary glasses frame to the temple of the ordinary eyeglasses are housed inside the temple like extension of the flexible auxiliary clip-on glasses frame.

In yet another embodiment, the flexible auxiliary clip-on glasses frame is mounted to the front of the ordinary eyewear. In another embodiment, the flexible auxiliary clip-on glasses frame is mounted to the back the ordinary eyewear. In yet another embodiment, the flexible auxiliary clip-on glasses frame is in the form of one piece lens construction. In yet another embodiment, the flexible auxiliary clip-on glasses frame contains a single lens construction where the single lens construction contains a left lens portion, a right lens portion, and a bridge portion connecting the left lens portion and the right lens portion.

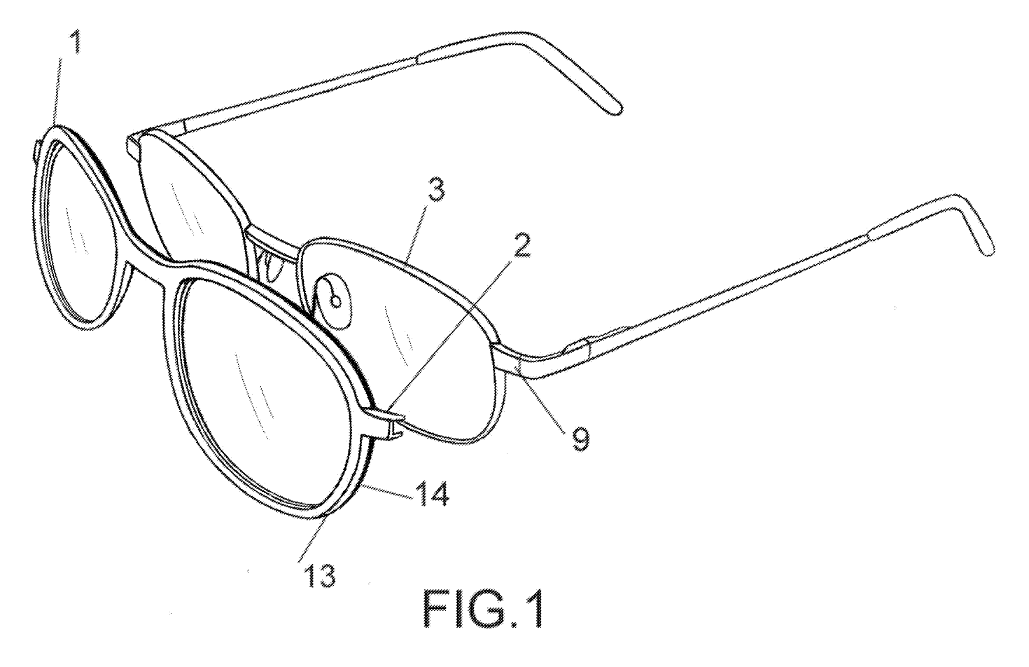

As shown in FIG. 1, the flexible auxiliary clip-on glasses frame of present invention is depicted. It includes an auxiliary glasses frame 1 incorporating a two layer design where the hard surface side (front side/convex side) of the frame is made with plastic or metal material 13 and the soft surface side (back side/concave side) of the frame is made with soft rubber like material 14. The auxiliary glasses frame 1 contains a left frame portion 15, a right frame portion 16, each frame containing lens retaining portion 17, and a bridge element 6. Clamps 2 formed on either side of the auxiliary glasses frame 1. FIG. 1 also depicts the ordinary eyeglasses frame 3 to which the auxiliary glasses frame 1 attaches to and is supported by. In this embodiment, the auxiliary glasses frame 1 attaches to the ordinary eyeglasses frame 3 by attaching the clamps 2 to the temple 9 of the ordinary eyeglasses frame 3.

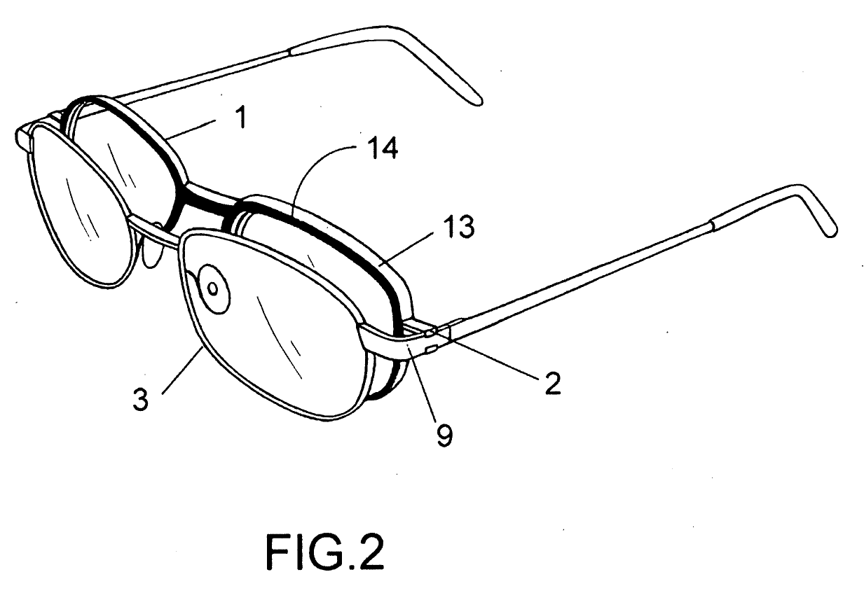

As shown in FIG. 2, flexible auxiliary clip-on glasses frame incorporating a two layer design of the present invention is depicted, which includes an auxiliary glasses frame 1 incorporating a two layer design where the hard surface side of the frame is made with plastic or metal material 13 and the soft surface side of the frame is made with soft rubber like material 14. In this depiction, the auxiliary glasses frame 1 is attached to the back of the ordinary eyewear frame 3 using clamps 2 designed to clamp to the temple 9 of the ordinary eyewear frame 3.

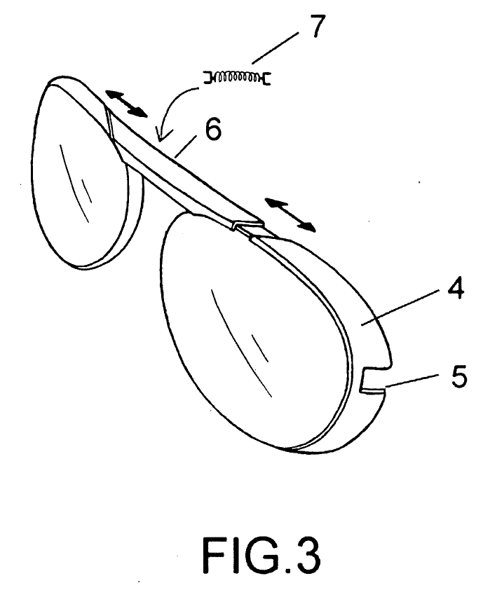

As shown in FIG. 3, another embodiment of the flexible auxiliary clip-on glasses frame of present invention is depicted, which includes an auxiliary glasses frame 4 made of flexible material such as soft plastic, silicon, soft rubber or similar soft material and niche like clamps 5 formed on either side of the auxiliary glasses frame 4 where the nice like clamps 5 is used to attaché the auxiliary glasses frame 4 to the temple 9 of the ordinary eyeglasses frame 3. Here the flexible auxiliary clip-on glasses frame incorporates spring mechanism 18 over the bridge element 6 of the auxiliary glasses frame 4 by enclosing spring mechanism 18 inside the auxiliary glasses frame 4.

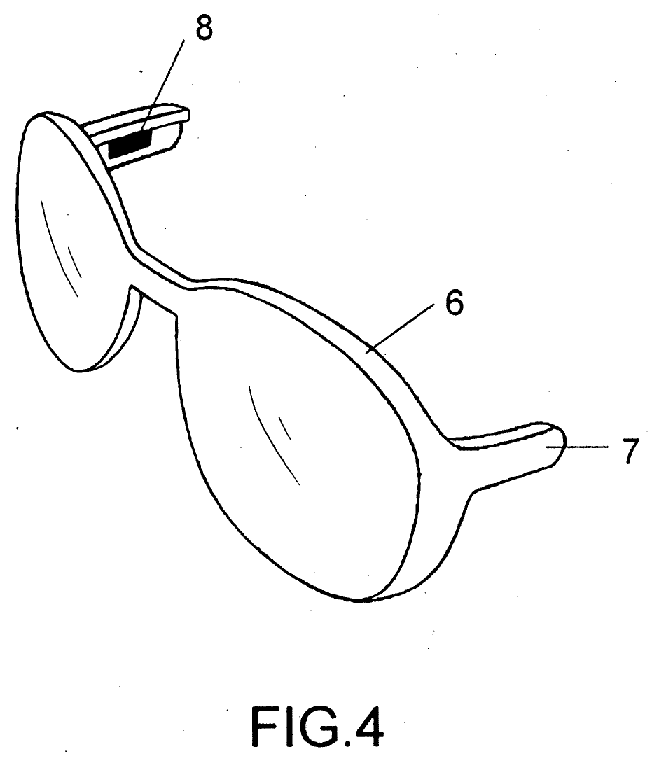

As shown in FIG. 4, another embodiment of the flexible auxiliary clip-on glasses frame of present invention is depicted, which includes an auxiliary glasses frame 4 made of flexible material such as soft plastic, silicon, soft rubber or similar soft material and the clip-on frame incorporates temple like extension 7 on both sides of the auxiliary glasses frame 6 and magnets 8 designed to attached the auxiliary glasses frame 6 to the temple 9 of the ordinary eyeglasses frame 3 are housed in the temple like extension 7. Here the auxiliary glasses frame 4 contains a single lens construction 11 where the single lens construction contains a left lens portion 19, a right lens portion 20, and a bridge portion 21 connecting the left lens portion 19 and the right lens portion 20.

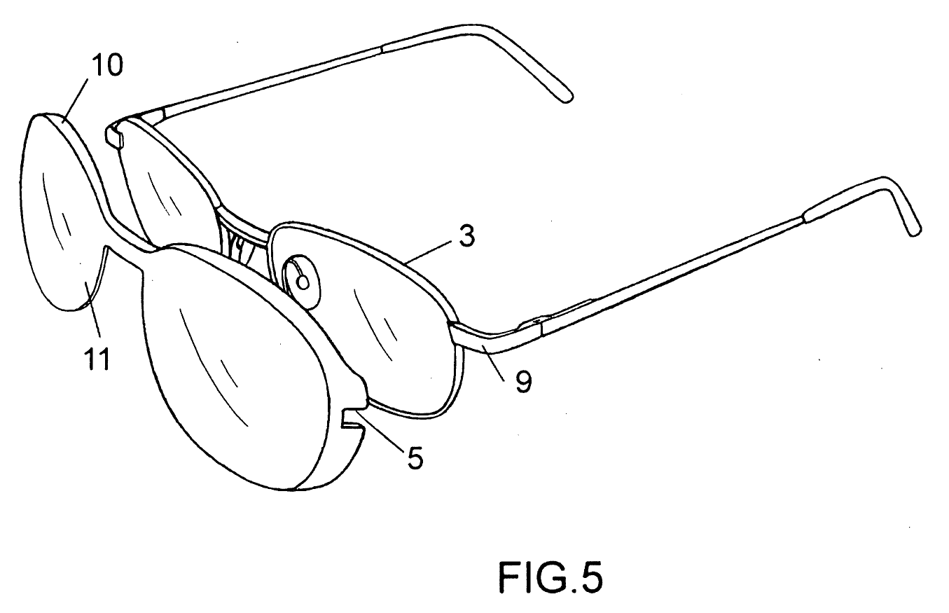

As shown in FIG. 5, another embodiment of the flexible auxiliary clip-on glasses frame of present invention is depicted, which includes an auxiliary glasses frame 4 made of flexible material such as soft plastic, silicon, soft rubber or similar soft material and the auxiliary glasses frame 4 further incorporates niche like clamps 5 where the niche like clamps 5 will attach the auxiliary glasses frame 4 to the temple 9 of the ordinary eyeglasses frame 3. Here the auxiliary glasses frame 4 contains a single lens construction 11 where the single lens construction contains a left lens portion 19, a right lens portion 20, and a bridge portion 21 connecting the left lens portion 19 and the right lens portion 20.

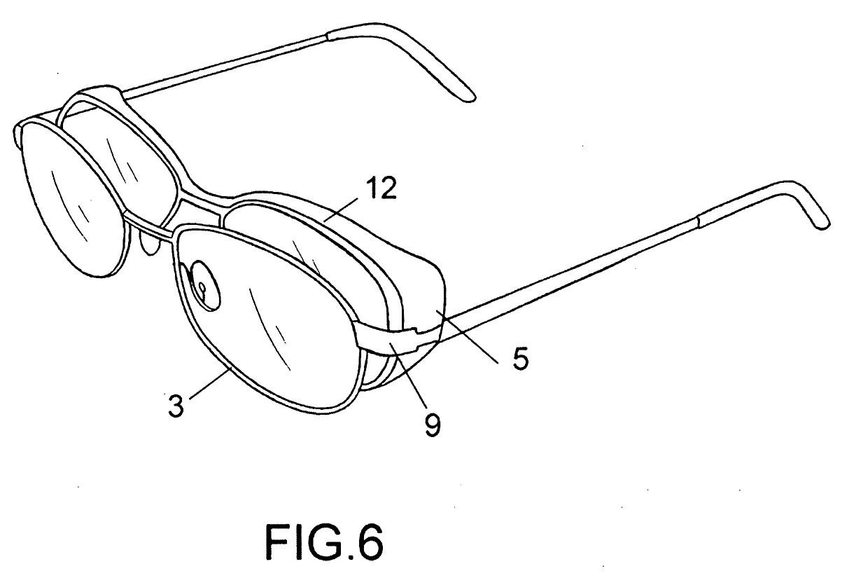

FIG. 6 depicts another embodiment of the flexible auxiliary clip-on glasses frame of present invention is depicted where an auxiliary glasses frame 4 made of flexible material such as soft plastic, silicon, soft rubber or similar soft material and the auxiliary glasses frame 4 further incorporates niche like clamps 5 and the niche like clamps 5 attaches the auxiliary glasses frame 12 to the temple 9 of the ordinary eyeglasses frame 3 and to the back of the ordinary eyeglasses frame 3.

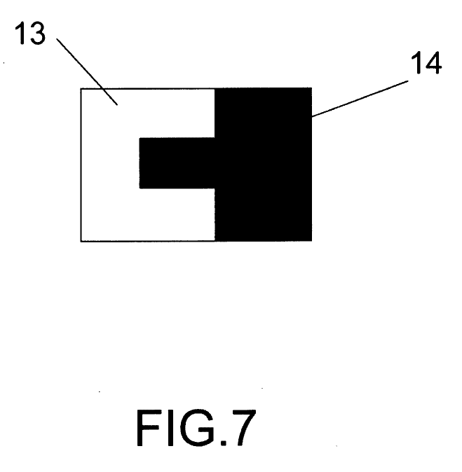

FIG. 7 is a cross sectional view of the embodiment of the flexible auxiliary clip-on glasses frame of FIG. 1 or FIG. 2 showing the frame utilizing a two layer design where the hard surface side is made with plastic, hand made sheet stock metal or metal compress die cut materials 13 and the soft surface side is made with layer of soft rubber or silicon or similar soft material 14. The two layers are combined using various available attachment methods such as the use of glue or the use of fasteners like screws or the likes.

What is claimed is:

1. An auxiliary clip-on frame for mounting on eyeglasses comprising an auxiliary glasses frame comprising a left frame part and a right frame part, each of said frame parts comprising lens retaining portion, a bridge element, and at least one clamp, where said auxiliary glasses frame is made of flexible material; wherein said auxiliary glasses frame is capable of attaching to an eyeglasses by attaching said clamp to said eyeglasses; wherein said auxiliary glasses frame will not scratch the surface of said eyeglasses when said auxiliary glasses frame is attached to said eyeglasses.

2. The frame of claim 1 wherein said flexible material is soft plastic, silicon, or soft rubber.

3. The frame of claim 1 wherein said auxiliary glasses frame contains lens or lenses.

4. The frame of claim 1 wherein said bridge element of said auxiliary glasses frame further contains shape memory alloy.

5. The frame of claim 4 wherein said shape memory alloy is embedded within said throughout the clip-on frame.

6. The frame of claim 1 wherein said bridge element contains a spring mechanism wherein said spring mechanism enables said left frame and said right frame of said auxiliary glasses frame to extent and retract from the center of said auxiliary glasses frame.

7. The frame of claim 1 wherein said clamp is capable of attaching to a bridge element of the eyeglasses.

8. The frame of claim 1 wherein said clamp is capable of attaching to at least one temple element of the eyeglasses.

9. The frame of claim 1 wherein said auxiliary glasses frame further comprising at least one temple like extension wherein at least one magnet is embedded within said extension wherein said magnet is capable of attaching said auxiliary glasses frame to said eyeglasses.

10. The frame of claim 1 wherein said auxiliary clip-on frame attaches to a front side of said eyeglasses.

11. The frame of claim 1 where said auxiliary clip-on frame attaches to a back side of said eyeglasses.

12. The frame of claim 1 where said clamp is a niche like clamp.

13. An auxiliary clip-on frame for mounting on eyeglasses comprising an auxiliary glasses frame comprising a left frame part and a right frame part, each of said frame parts comprising lens retaining portion, a bridge element, and at least one clamp, wherein a front side of the auxiliary glasses frame is made with plastic or metal material and a back side of the auxiliary glasses frame is made with soft rubber like material; wherein said auxiliary glasses frame is capable of attaching to an eyeglasses by attaching said clamp to said eyeglasses; wherein said auxiliary glasses frame will not scratch the surface of said eyeglasses when said auxiliary glasses frame is attached to said eyeglasses.

14. The frame of claim 13 where said auxiliary glasses frame contains lens or lenses.

15. The frame of claim 13 where said soft rubber like material is soft rubber or silicon.

16. The frame of claim 13 where said bridge element of said auxiliary glasses frame further contains shape memory alloy.

17. The frame of claim 13 wherein said front side of said auxiliary glasses is attached to said back side of said auxiliary glasses frame by the use of glue.

18. The frame of claim 13 where said front side of the auxiliary glasses frame is attached to said back side of the auxiliary glasses frame made by the use of at least one screw.

19. The frame of claim 13 where said bridge element contains a spring mechanism where the spring mechanism enables said left frame and said right frame of said auxiliary glasses frame to extent and retract from the center of said auxiliary glasses frame.

20. The frame of claim 13 where said clamp is capable of attaching to a bridge element of the eyeglasses.

21. The frame of claim 13 where said clamp is capable of attaching to at least one temple element of the eyeglasses.

22. The frame of claim 13 where said auxiliary glasses frame further comprising at least one temple like extension where at least one magnet is attached to said extension where said magnet is capable of attaching said auxiliary glasses frame to said eyeglasses.

23. The frame of claim 13 where said auxiliary glasses frame attaches to a front side of said eyeglasses.

24. The frame of claim 13 where said auxiliary glasses frame attaches to a back side of said eyeglasses.

25. The frame of claim 13 where said clamp is a niche like clamp.
